(19) United States
(12) Patent Application Publication
(10) Pub. No.: US 2006/0021830 A1
(43) Pub. Date: Feb. 2, 2006

(54) Cycling exerciser with single cable actuator for brake and resistance adjustment

(76) Inventors: Todd W. Lassanske, Madison, WI (US); You-Chun Chu, Taichung City (TW); Chien-Chang Wu, Tainan Hsien (TW)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/192,646

(22) Filed: Jul. 29, 2005

Related U.S. Application Data
(60) Provisional application No. 60/592,262, filed on Jul. 29, 2004.

(51) Int. Cl. F16D 65/14

(52) U.S. Cl. 188/2 D

(57) ABSTRACT

A cable-type actuator assembly for a cycling exerciser having a cable operated resistance adjustment mechanism and a cable operated braking system. The actuator assembly includes a caliper actuation cable operably connected to a caliper that acts on a wheel of the cycling exerciser. An actuator is mounted to the frame of the exerciser, and retains the distal ends of a brake cable and a resistance adjustment cable and is connected to a forward end of the caliper actuation cable. Actuation of either the brake cable or resistance adjustment cable moves the actuator, thereby actuating the caliper actuation cable.

### CROSS REFERENCE TO RELATED APPLICATIONS

This application claims priority from U.S. Provisional Application Ser. No. 60/592,262 filed on Jul. 29, 2004, which is hereby incorporated herein by reference in its entirety.

### FIELD OF THE INVENTION

The present invention relates generally to a brake and a resistance adjuster for an exercise device that includes a rotating member such as a flywheel, such as a cycling exerciser. More specifically, the invention relates to a single cable actuator assembly that allows for a single caliper actuation cable to be actuated by either a brake cable or a resistance adjustment cable of an exercise device.

### BACKGROUND OF THE INVENTION

In recent years, there has been increasing interest in and use of stationary exercise bicycles, commonly referred to as “spin bikes,” which incorporate a rotating flywheel. As a result, many manufacturers of road bicycles or other exercise equipment have also developed a line of stationary exercise bikes or spin bikes to meet this new demand. Despite the obvious differences in the use and operational environment between road bicycles and exercise or spin bikes, many manufacturers of spin bikes have incorporated mechanisms developed initially for road bicycles into the stationary exercise or spin bikes.

For example, many stationary exercise or spin bikes employ a flywheel braking mechanism that is similar to the braking mechanisms incorporated in road bicycles. In such instances, a hand brake mounted on the handlebars is connected to a brake cable that extends reawardly over the length of the frame to the caliper of the brake assembly. Actuation of the hand brake is translated through the brake cable to the caliper to cause attached brake pads to press against the flywheel, thereby performing a braking function.

In addition to the braking mechanism, most stationary exercise of spin bikes also have a separate resistance adjustment mechanism operably connected to the flywheel. Most prior art devices include a resistance adjustment device connected to the handlebars or frame of the bicycle. The resistance adjustment mechanism is connected to a separate resistance adjustment cable that also extends rearwardly over the length of the bicycle to the caliper or other resistance-providing mechanism. Actuation of the resistance adjustment device is translated through the resistance adjustment cable to the caliper or other resistance-providing mechanism to cause the resistance adjustment mechanism to press against the flywheel, thereby increasing resistance.

The prior art devices result in a complex assembly employing multiple cables extending across the frame of the exercise bicycle, which can be cumbersome and unsightly. Thus, there is a need for a more simplified braking and resistance adjustment mechanism for cycling exercisers that employs fewer cables and a single cable actuator extending to the flywheel of a cycling exerciser that is capable of providing both a braking function and resistance adjustment.

### SUMMARY OF THE INVENTION

It is an object of the present invention to provide a single cable system for providing both a braking function and a resistance adjustment function in an exercise device that includes a rotating member, such as a flywheel. It is a further object of the invention to provide a system that magnifies axial movement of a cable-type actuator for providing either a braking function or a resistance adjustment function in such an exercise device. Yet another object of the invention is to provide such a system that provides both a braking function and a resistance adjustment function, in response to separate brake and resistance adjustment actuators.

In accordance with a first aspect of the present invention, there is provided a single cable actuator assembly for a cycling exerciser. The cycling exerciser includes a cable operated resistance adjustment mechanism and a cable operated braking mechanism. The single cable actuator assembly includes a caliper actuation cable operably connected to a caliper that acts on a rotating member, such as the flywheel, of the cycling exercise. The single cable actuator assembly further includes an actuator mounting bracket secured to the frame of the exerciser, and an actuator movably mounted to the actuator mounting bracket. The distal ends of both a brake cable and a resistance adjustment cable are secured to the actuator. The forward end of a caliper actuation cable is also secured to the actuator, such that actuation of either the brake cable or the resistance adjustment cable moves the actuator so as to cause movement of the caliper actuation cable.

The actuator may include a brake cable-receiving cradle configured to retain the brake cable and a resistance adjustment cable-receiving cradle configured to retain the resistance adjustment cable. The brake cable receiving cradle and the resistance adjustment cable-receiving cradle define recesses or cavities configured to engage the respective brake cable and resistance adjustment cable via a lug or fastener secured to the end of each of the cables. The actuator mounting bracket may be mounted to an upper frame member of the exerciser, and a shroud configured to receive a water bottle may be mounted to the upper frame member so as to cover the actuator mounting bracket.

In one embodiment, the actuator is a pivotally mounted swing plate. The swing plate includes a brake cable receiving cradle configured to retain the brake cable, a resistance adjustment cable receiving cradle configured to retain the resistance adjustment cable, and a caliper actuation cable configured to retain the caliper actuation cable. The brake cable receiving cradle and the resistance adjustment cable receiving cradle are aligned on the swing plate. The resistance adjustment cable receiving cradle is located outwardly of the brake cable receiving cradle relative to the pivot of the swing plate. In this manner, the swing plate experiences a greater degree of travel upon operation of the brake actuator than upon operation of the resistance adjustment mechanism. This feature enables quick response for brake application, and also provides a mechanical advantage to facilitate quick and easy resistance adjustment.

In another embodiment, the actuator is in the form of a spool that is rotatably mounted to the actuator mounting bracket. In yet another embodiment, the actuator is a slider that is slidably engaged with the actuator mounting bracket. The slider retains the distal ends of the brake cable and the resistance adjustment cable, and the forward end of the caliper actuation cable is mounted to the slider for movement in response to movement imparted to the slider upon movement of either the brake cable or the resistance adjustment cable.

In accordance with a further aspect of the present invention, there is provided a method of mounting a caliper actuation cable in a cycling-type exerciser in which a caliper acts on a flywheel to provide both a resistance function and a braking function. The method includes the steps of mounting an actuator to the frame of the exerciser, and connecting both the brake cable and the resistance adjustment cable to the actuator. The method further includes the step of connecting the caliper actuation cable to the actuator, such that movement of the actuator by the attached brake cable or the attached resistance adjustment cable actuates the caliper actuation cable. The actuator may be in the form of a pivotally mounted swing plate, a rotatable spool, or a slider the is slidably mounted to an actuator mounting bracket.

In accordance yet another aspect of the present invention, there is provided a single cable actuator for a cycling exerciser that includes a mounting member secured to the frame of the exerciser, and a cable retaining member movably mounted to the mounting member. The cable retaining member retains the distal ends of a brake cable and a resistance adjustment cable, and is connected to a forward end of a caliper actuation cable. Actuation of either the brake cable or the resistance adjustment cable moves the cable retaining member, thereby actuating the caliper actuation cable. The cable retaining member may be pivotally, rotatably or slidably mounted to the mounting member.

In accordance with a still further aspect of the present invention, a cable-type actuating assembly includes an input member and an axially movable output member. The input member is interconnected with an input actuator, and operation of the input actuator causes axial movement of the input member. A pivoting intermediate operator is located between the input member and the output member. The intermediate operator is pivotable about a pivot axis and includes a first engagement area with which the input member is engaged at a first location relative to the pivot axis, and a second engagement area with which the output member is engaged at a second location outwardly of the first location relative to the pivot axis. Axial movement of the input member by operation of the input actuator causes axial movement of the output member through the intermediate operator, and engagement of the output member with the intermediate operator at the second location results in greater axial movement of the output member than the input member. Representatively, the input member may be either a brake actuator cable or a resistance adjustment cable in an exercise device having a rotating member such as a flywheel, in which the braking and resistance functions are provided by a caliper that acts on the flywheel in response to a caliper actuation cable secured to the intermediate operator. Preferably, both the brake actuator cable and the resistance adjustment cable are engaged with the intermediate operator. The brake actuator cable and the resistance adjustment cable are engaged with the intermediate operator in different locations relative to the pivot axis, to provide different degrees of travel of the caliper actuation cable in response to movement of either the brake actuator cable or the resistance adjustment cable. This aspect of the invention also contemplates a method of actuating a device using an output member interconnected with the device, substantially in accordance with the foregoing summary.

Various other features, objects and advantages of the invention will be made apparent from the following description taken together with the drawings.

### BRIEF DESCRIPTION OF THE DRAWINGS

The drawings illustrate the best mode presently contemplated of carrying out the invention. In the drawings:

FIG. 1 is an isometric view of a cycling exerciser incorporating a cable-type actuator assembly in accordance with the present invention;

FIG. 2 is an enlarged partial side elevation view of the cable-type actuator assembly incorporated in the cycling exerciser of FIG. 1;

FIG. 3 is a top plan view of the cable-type actuator assembly of FIG. 2;

FIG. 4 is a further enlarged side elevation view of a swing plate actuator incorporated in the cable-type actuator assembly of FIG. 2, showing the swing plate moved forwardly from a rest position to a first actuating position;

FIG. 5 is a side elevation view similar to FIG. 4 showing the swing plate actuator moved forwardly from the rest position to a second actuating position;

FIG. 6 is a side elevation view of a second embodiment of the cable-type actuator assembly of the present invention in which the actuator of the assembly is in the form of a rotatable spool;

FIG. 7 is a partial isometric view of a third embodiment of the cable-type actuator assembly of the present invention in which the actuator of the assembly is in the form of a slider;

FIG. 8 is a sectional view of the third embodiment of the cable-type actuator assembly taken along line 8-8 of FIG. 7;

FIG. 9 is a top plan view of the cable-type actuator assembly of FIG. 7;

FIG. 10 a top plan view of the single cable actuator assembly of FIG. 7 showing the slider moved forwardly into a first actuating position by the actuation of a brake cable; and

FIG. 11 is a top plan view of the single cable actuator assembly of FIG. 7 showing the slider moved forwardly into a second actuating position by the actuation of a resistance adjustment cable.

### DETAILED DESCRIPTION OF THE PREFERRED EMBODIMENTS

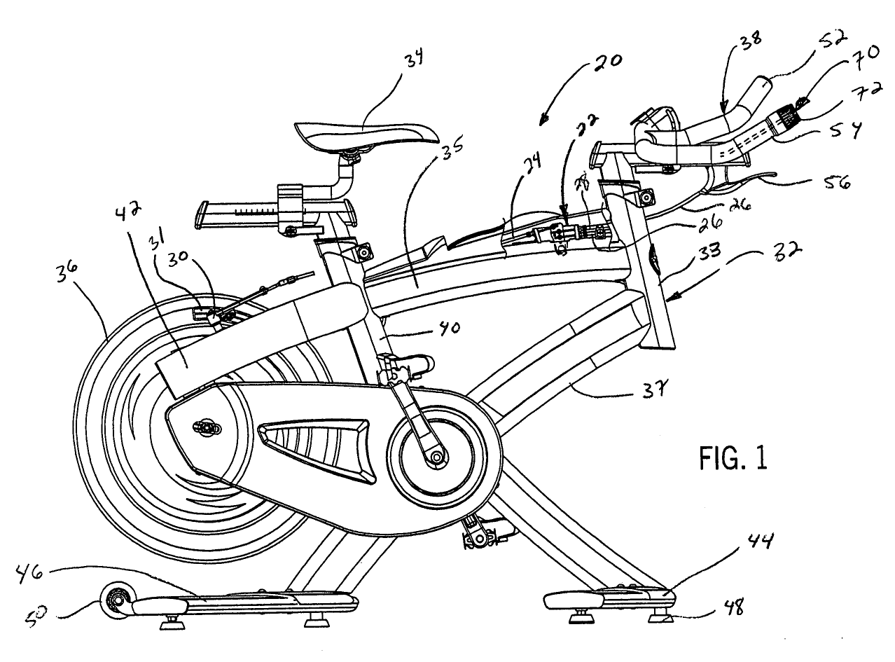

Referring to FIG. 1, the present invention contemplates a cycling exerciser, shown generally at 20, that includes a cable-type actuator assembly 22 for braking and for user applied resistance adjustment. The cable-type actuator assembly 22 allows for a single caliper actuation cable 24 to be actuated by either a brake cable 26 or a resistance adjustment cable 28 of the cycling exerciser 20. In a manner to be explained, cable-type actuator assembly 22 can be used to actuate a caliper 30 or other resistance means on cycling exerciser 20.

Cycling exerciser 20 includes a self-supporting frame 32. Attached to frame 32 are an adjustable seat 34, a flywheel or wheel 36 and handlebars 38. Frame 32 can take a variety of configurations, and is shown in the illustrated embodiment as a rear wheel spin bike incorporating a “forkless frame.” Frame 32 is generally diamond-shaped and includes a neck 33, an upper frame member 35, a lower frame member 37, an upright seat support 40 and a rear fork 42. A front support member 44 and a rear support member 46 are connected to frame 32 and elevate frame 32 off the ground or other support surface, such that wheel 36 spins freely in the air. As illustrated in FIG. 1, support members 44, 46 may also include feet 48 to raise the frame 32 off the ground. A transport wheel 50 may also be included to assist a user in moving the cycling exerciser 20.

“Bull-horn” handlebars 38 are adjustably attached to the front of the frame 32 above neck 33. Handlebars 38 include at least one right handle 54 and one left handle (not shown). Handlebars 38 may additionally include an alternative upright right handle 52 and upright left handle (not shown), which can be utilized when a rider desires a more upright riding position when exercising.

At least one brake lever or hand brake 56 is connected to either the left handle or the right handle 54. Hand brake 56 may be of the conventional type and is operably connected to a brake cable 26 in a manner known in the art. Brake cable 26 is preferably surrounded by a plastic or rubber sheath 58, in a known manner. Sheath 58 and brake cable 26 extend downwardly from handlebars 38 in a direction towards the upper frame member 35 of the bike frame 32.

Sheath 58 and brake cable 26 engage a cylindrical threaded collar 66, which is connected to a threaded receiver 65 secured to the outside of an actuator mounting or receiving bracket 68 incorporated in the cable-type actuator assembly 22.

On either the left handle or the right handle 54, a resistance adjustment mechanism 70 is attached to the handlebars 38. Resistance adjustment mechanism 70 can take a variety of configurations. In the illustrated embodiment, resistance mechanism 70 is in the form of a threaded adjustment knob 72 connected to the distal end of either the left handle or the right handle 54. Adjustment knob 72 is connected to one end of a resistance adjustment cable 28 in a manner such that rotation of knob 72 either tightens or loosens resistance adjustment cable 28. Resistance adjustment cable 28 is also preferably surrounded by a plastic or rubber sheath 74, in a manner as is known. Sheath 74 and resistance adjustment cable 28 extend from knob 72 through the interior of handlebars 38 toward the frame 32. Sheath 74 and resistance adjustment cable 28 exit the handlebars 38 from a hole (not shown) and extend downwardly in a direction towards the upper frame member 35 of the frame 32.

Resistance adjustment cable 28 and sheath 74 engage a second cylindrical threaded collar 80, which is connected to a threaded receiver 65 secured to the outside of actuator mounting or receiving bracket 68 incorporated in the cable-type actuator assembly 22.

Cable-type actuator assembly 22 is generally comprised of an actuator or cable retaining member 86 movably mounted on actuator receiving bracket 68 and movable between first and second walls defined by the actuator receiving bracket 52. It will become apparent from the following description that actuator 86 and actuator receiving bracket 68 can take a variety of configurations. In the embodiment illustrated in FIGS. 1-5, actuator receiving bracket 68 is in the form of a pivot-type receiving bracket 67. Actuator 86 is in the form of a generally rectangular, pivotally mounted swing plate 88 that is movable between a first transverse wall 82 and a second transverse wall 84 defined by the pivot receiving bracket 67.

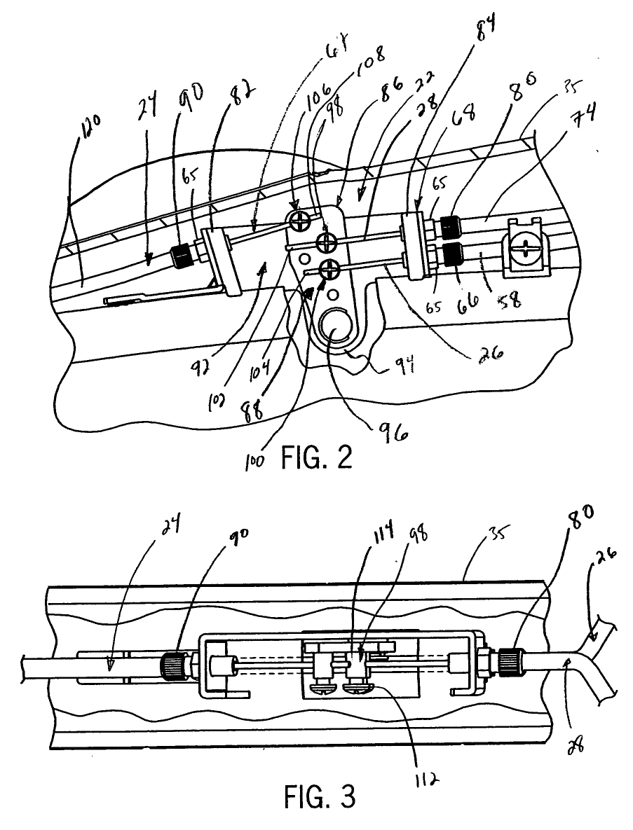

As best illustrated in FIGS. 2-5, pivot receiving bracket 67 is fastened to the upper frame member 35. Pivot receiving bracket 67 is a generally rectangular member that includes transverse wall 84, with which threaded collars 66 and 80 are engaged through threaded receivers 65. Pivot receiving bracket 67 also includes transverse wall 82 opposite the wall 84. A threaded collar 90, which is secured to the end of caliper actuation cable 24, is engaged with transverse wall 82 through a threaded receiver 65. An axial wall 92 extends between and interconnects transverse walls 82, 84. Axial wall 92 includes a pivot connection extension 94, which extends downwardly from the lower edge of axial wall 92 through an opening formed in the upper wall of upper frame member 35. A pivot pin 96 extends through pivot connection extension 94 and pivotally connects swing plate 88 to the pivot receiving bracket 67.

Swing plate 88 is configured to pivot within the area between transverse walls 82 and 84. Located on the right side of the swing plate 88 in a generally central location is a resistance adjustment cable cradle 98. Located below and aligned with the resistance adjustment cable cradle 98 is a brake cable cradle 100. Resistance adjustment cable cradle 98 and brake cable cradle 100 are configured to retain the exposed terminal ends 102, 104 of resistance adjustment cable 28 and brake cable 26, respectively. In the upper left corner of the swing plate 88, opposite the pivot pin 96, is a single caliper actuation cable cradle 106 configured to receive the exposed terminal end 108 of caliper actuation cable 24.

As referenced above, the exposed terminal end 104 of brake cable 26 and the exposed terminal end 102 of resistance adjustment cable 28 extend through the collars 66, 80 into the pivot receiving bracket 67. Resistance adjustment cable terminal end 102 extends from stop 80 through transverse wall 84 into the resistance adjustment cable cradle 98 mounted to the swing plate 88. Resistance adjustment cable cradle 98 is a hollow member configured to receive a fastener 112 therein, in a known manner. Resistance adjustment cable terminal end 102 is inserted through a hole 114 in resistance adjustment cable cradle 98. The resistance adjustment cable terminal end 102 is then crimped onto the fastener 112 within the resistance adjustment cable cradle 98 using fastener 112, such that resistance adjustment cable 28 is operably connected to the swing plate 88.

In a similar manner, brake cable terminal end 104 extends from stop 66 through transverse wall 84 into the brake cable cradle 100 mounted to the swing plate 88. Brake cable cradle 100 is also a hollow member configured to receive a fastener 116 therein. Brake cable terminal end 104 is inserted through a hole in brake cable cradle 100. The brake cable terminal end 104 is then crimped onto the fastener 116 within the brake cradle 100 such that brake cable 26 is also operably connected to the swing plate 88.

Caliper actuation cable 24 extends from the pivot receiving bracket rear transverse wall 82. Caliper actuation cable 24 extends through pivot receiving bracket rear wall 82 through collar 90. Rearward of the collar 90, actuation cable 24 is preferably surrounded by a plastic or rubber sheath 120 in a manner as is known. Sheath 120 and actuation cable 24 extend from pivot receiving bracket rear wall 82 along upper frame member 35 towards caliper 30. Caliper actuation cable 24 continues toward the rear of the exerciser 20 to a termination point where it is operably connected to caliper 30, in a known manner. As will be discussed in greater detail below, movement of actuation cable 24 moves caliper 30 and any attached pads 31 either against or away from wheel 36 such that caliper 30 either clamps onto or releases wheel 36.

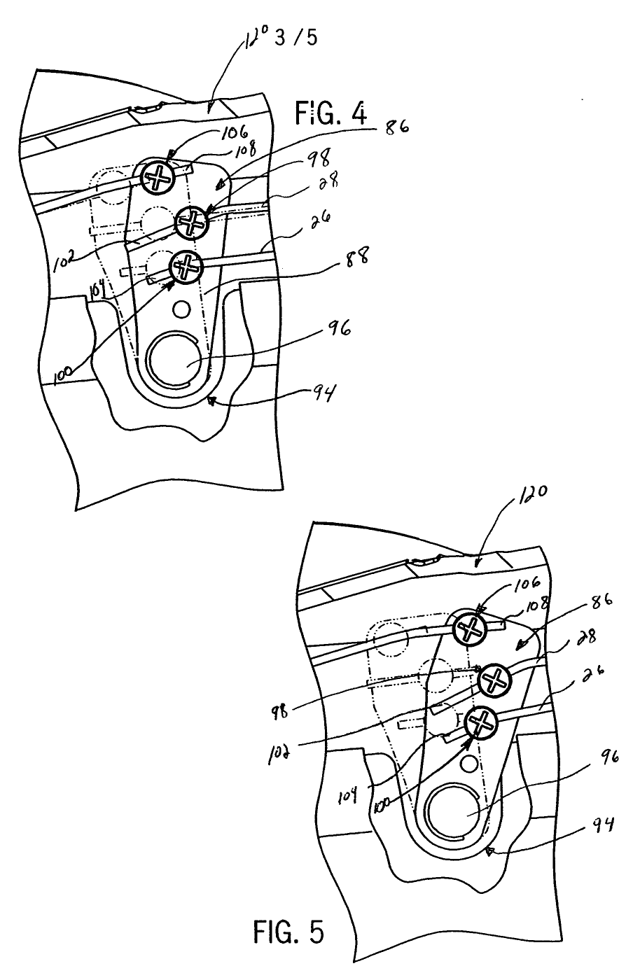

In the illustrated embodiment, a single caliper 30 is utilized in both braking and user applied resistance functions. In operation, if a user desires more resistance during his or her exercise, the user rotates the knob 72 in, for example, the clockwise direction. Rotation of knob 72 draws resistance adjustment cable 28 towards knob 72. The movement of resistance adjustment cable 28 is translated down cable 28 to swing plate 88, and pivots the swing plate 88 forward in a direction towards the handlebars 38 (FIGS. 4 and 5). As the swing plate 88 moves forward, the caliper actuation cable cradle 106 connected to the end of caliper actuation cable 24 is pulled forwardly along with the swing plate 88. As a result, caliper actuation cable 24 is drawn forward, thereby actuating caliper 30 located at its opposite end. The tightening or forward movement of caliper actuation cable 24 causes caliper and any attached resistance pads to clamp onto wheel 36, thereby increasing resistance. Alternatively, if the user desires to lessen the amount of resistance, the user rotates the knob 72 in the counter clockwise direction. Rotation in the counterclockwise direction loosens the resistance adjustment cable 28, thereby releasing the swing plate 88 which then moves rearwardly releasing the tension in caliper actuation cable 24, thereby at least partially releasing the caliper 30 and any attached pads from wheel 36 under the influence of a spring bias incorporated resistance adjustment knob 72 or in caliper 30, in a known manner. Thus, cable-type actuator assembly 22 allows a user to selectively control the amount of resistance applied to the wheel 30.

In a similar manner as described above, brake cable 26 can be utilized to actuate caliper 30. Actuation of hand brake 56 in a manner known in the art increases tension and draws brake cable 26 forward. The movement of brake cable 26 is translated through cable 26 to swing plate 88 and effectively pulls swing plate 88 forward in a direction towards the handlebars 38. As the swing plate 88 moves forwardly, the end of caliper actuation cable 24 is pulled forwardly along with the swing plate 88. As a result, caliper actuation cable 24 is drawn forward thereby actuating caliper 30 located as its opposite end. The tightening or forward movement of caliper actuation cable 24 causes caliper 30 and any attached resistance pads 31 to clamp around wheel 36, thereby performing a braking function on wheel 36. Upon release of the hand brake, a spring associated with hand brake 56, in a known manner, functions to move hand brake 56 back to its resting position, thereby loosening the brake cable 26 and releasing the swing plate 88. Swing plate 88 then moves rearwardly, which may be assisted by a spring bias incorporated into caliper 30, so as to release the tension in caliper actuation cable 24, thereby releasing the caliper 30 and any attached pads from wheel 36.

The orientation of the brake cable cradle 100 and the resistance adjustment cable cradle 98 may be varied. However, in the embodiment illustrated in FIGS. 1-5, the resistance adjustment cable cradle 98 is located above the brake cable cradle 100 at a distance further from the pivot pin 96. This construction is advantageous, in that the hand brake 56 has much more travel than the illustrated threaded resistance adjustment knob 72. Thus, the illustrated orientation allows the resistance adjustment knob 72 to take advantage of the greater distance of the resistance adjustment cable cradle 98 from the pivot point, relative to that of brake cable cradle 100, to reduce the number of turns required to adjust resistance.

Preferably, the components of the cable-type actuator assembly 22 are housed within a protective shroud 120 removably attached to the upper frame member 35 of the frame 32. In the illustrated embodiment, the protective shroud 120 is designed as a cradle configured to retain a water bottle (not shown).

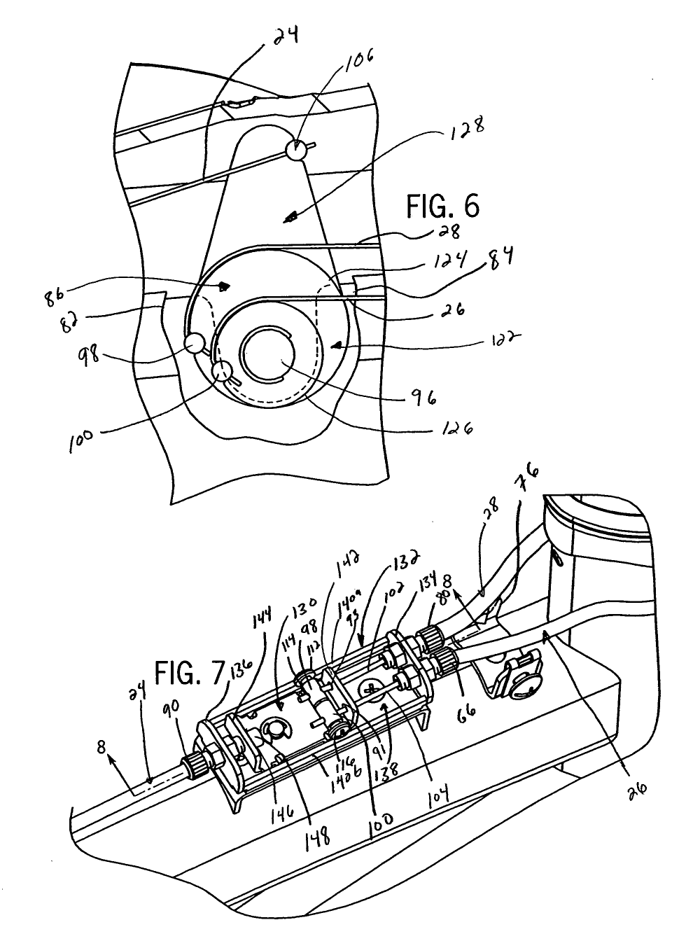

FIG. 6 illustrates an alternative embodiment of the actuator or cable retaining member 86 movably mounted on the pivot receiving bracket 67. In the embodiment illustrated in FIG. 6, actuator 86 is in the form of a rotatable spool 122. Spool 122 is rotatable around pivot pin 96. Spool 122 includes an outer surface 124 configured to receive the resistance adjustment cable 28. A resistance adjustment cable cradle 98 similar to that previously described is located on the outer surface 124. Concentrically inward of the outer surface 124 is an inner surface 126. Inner surface 126 is configured to receive brake cable 26. A brake cable cradle 100 similar to that previously described is located on the inner surface 126. A caliper actuation cable receiving plate 128 extends upwardly from the spool and includes a single caliper actuation cable cradle 106 configured to receive the caliper actuation cable 24.

Spool 122 is configured to rotate within the area defined by pivot receiving bracket transverse walls 82 and 84. In this embodiment, if a user desires more resistance during his or her exercise, the user rotates the knob 72 in, for example, the clockwise direction. Rotation of knob 72 draws resistance adjustment cable 28 towards knob 72. The movement of resistance adjustment cable 28 is translated down cable 28 to spool 122 and effectively rotates the spool 122 forward in a clockwise direction towards the handlebars 38. As the spool 122 rotates, the single caliper actuation cable cradle 106 connected to the end of caliper actuation cable 24 is pulled forwardly along with the caliper actuation cable receiving plate 128 connected to the spool 122. As a result, caliper actuation cable 24 is drawn forward thereby actuating caliper 30 located as its opposite end. The tightening or forward movement of caliper actuation cable 24 causes caliper 30 and any attached resistance pads to clamp around wheel 36, thereby increasing resistance. Alternatively, if the same user or a subsequent user desires to lessen the amount of resistance, the user rotates the knob 72 in the counter clockwise direction. Rotation in the counterclockwise direction loosens the resistance adjustment cable 28, thereby releasing the spool 122. Spool 122 then rotates in a counter clockwise direction and releases the tension in caliper actuation cable 24, thereby at least partially releasing the caliper 30 and any attached pads from wheel 36.

In a similar manner as described above, brake cable 26 can be utilized to actuate caliper 30. Actuation of hand brake 56 in a manner known in the art increases tension and draws brake cable 26 forward. The movement of brake cable 26 is translated through cable 26 to spool 122 and effectively rotates spool 122 forward in a clockwise direction. As the spool 122 rotates, the end of caliper actuation cable 24 is pulled forwardly along with the caliper actuation cable receiving plate 128 connected to the spool 122. As a result, caliper actuation cable 24 is drawn forward, thereby actuating caliper 30 located as its opposite end. The tightening or forward movement of caliper actuation cable 24 causes caliper 30 and any attached resistance pads 31 to clamp around wheel 36, thereby performing a braking function on wheel 36. Upon release of the hand brake, a spring (not shown) moves the brake handle back to its resting position thereby loosening the brake cable 26 and releasing the spool 122, which then moves reawardly and releases the tension in caliper actuation cable 24, thereby releasing the caliper 30 and any attached pads from wheel 36.

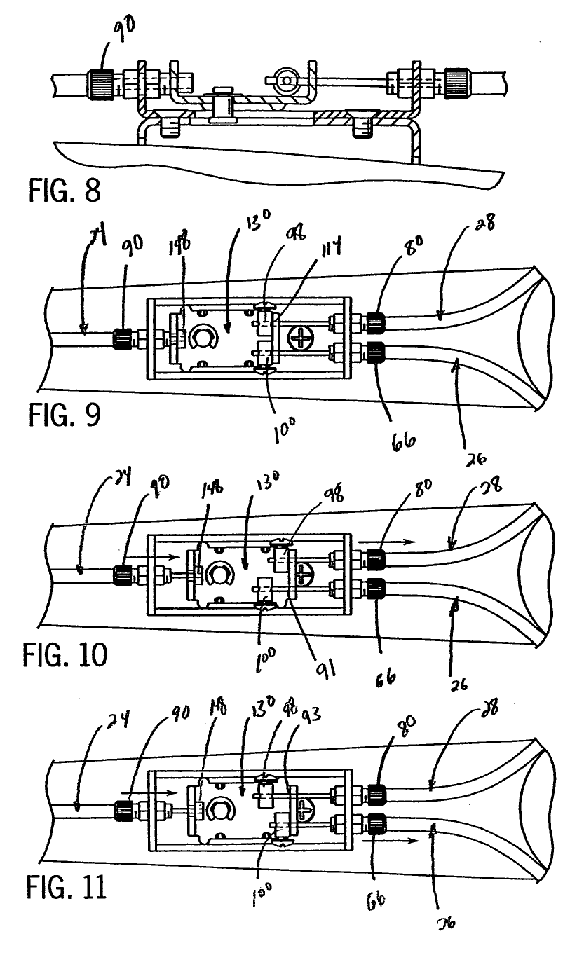

FIGS. 7-11 illustrate a third embodiment of the actuator or cable retaining member 86. Actuator 86 is comprised of a slider 130 slidably mounted on a slider bracket 132 and movable between first 134 and second 136 walls of the slider bracket 132. In the illustrated embodiment, slider bracket 132 is fastened to the upper frame member 35. Slider bracket 132 is a rectangular member comprised of a first wall 134 to which cylindrical collars or stops 80 and 66 are connected, and a second wall 136 opposite the first wall 134 to which a caliper actuation cable collar or stop 90 is mounted. Between first 134 and second 136 walls of the slider bracket 132 is the slider surface 138 upon which slider 130 is laterally movable. Slider surface 138 is bordered by sidewalls 140a, 140b configured to fit around and retain slider 130.

Slider 130 is a generally rectangular member configured to slidably fit within the area defined by slider bracket first 134 and second 136 walls and sidewalls 140a, 140b. At one end, slider 130 defines a front wall 142 that includes a resistance adjustment cable cradle 98 and a brake cable cradle 100 configured to retain the exposed terminal ends 102, 104 of resistance adjustment cable 28 and brake cable 26 respectively, as previously described. Opposite the cradles 98, 100 of the slider 130 is a slider rear wall 144. Slider rear wall 144 includes a hole 146 configured to receive the exposed terminal end 108 of a single caliper actuation cable 24. The exposed terminal end 108 of the caliper actuation cable 24 extends through hole 146 and is received within slider 130 by a boss 148. Boss 148 engages the inner side of slider rear wall 144 and prevents caliper actuation cable 24 from moving through hole 146.

The exposed terminal end 104 of brake cable 26 and the exposed terminal end 102 of resistance adjustment cable 28 extend through the collars 80, 66 into the slider bracket 132. Resistance adjustment cable terminal end 102 extends from collar 80 through first wall 142 into the resistance adjustment cable cradle 98 mounted onto the upper surface if the slider 130. Resistance adjustment cable terminal end 102 is inserted through a hole 114 in resistance adjustment cable cradle 98. The resistance adjustment cable terminal end 102 is then crimped onto the fastener 112 within the resistance adjustment cable cradle 98 such that resistance adjustment cable 28 is operably connected to the slider 130.

In a similar manner, brake cable terminal end 104 extends from stop 66 through first wall 142 into a brake cable cradle 100 mounted to the upper surface of the slider 130. Brake cable terminal end 104 is inserted through a hole in brake cable cradle 100. The brake cable terminal end 104 is then crimped onto the fastener 116 within the brake cradle 100 such that brake cable 26 is also operably connected to the slider 130.

Caliper actuation cable 24 extends from the slider rear wall 144. Actuation cable 24 extends through slider rear wall 144 into collar 90 towards caliper 30 as previously described. If a user desires more resistance during his exercise, the user rotates the knob 72 in, for example, the clockwise direction. Rotation of knob 72 draws resistance adjustment cable 28 towards knob 72. The movement of resistance adjustment cable 28 is translated down cable 28 to slider 130 and effectively pulls slider 130 forward along the slider bracket 132 in a direction towards the handlebars 38 (FIG. 10). As the slider 130 moves forward, boss 148 connected to the end of caliper actuation cable 24 engages the slider rear wall 144 and is pulled forwardly along with the slider 130. As a result, caliper actuation cable 24 is drawn forward thereby actuating caliper 30 located as its opposite end. The tightening or forward movement of caliper actuation cable 24 causes caliper 30 and any attached resistance pads 31 to clamp onto wheel 36, thereby increasing resistance. Alternatively, if the same user or a subsequent user desires to lessen the amount of resistance, the user rotates the knob 72 in the counter clockwise direction. Rotation in the counterclockwise direction loosens the resistance adjustment cable 28, thereby releasing the slider 130 which then moves rearwardly so as to release the tension in caliper actuation cable 24, thereby at least partially releasing the caliper 30 and any attached pads from wheel 36.

It should be appreciated that, in the embodiment illustrated in FIGS. 7-11, as the resistance adjustment cable 28 is drawn forward, the brake cable 26 remains unaffected. The end of brake cable 26 opposite the crimped end in the cradle 100 is essentially free. Thus, as slider 130 moves with resistance adjustment cable 28, slider 130 moves forward and brake cable passes 26 through hole 91 without encumbering the movement of slider 130.

In a similar manner as described above, brake cable 26 can be utilized to actuate caliper 30. Actuation of hand brake 56 in a manner known in the art increases tension and draws brake cable 26 forward. The movement of brake cable 26 is translated through cable 26 to slider 130 and effectively pulls slider 130 forward along the slider bracket 132 in a direction towards the handlebars 38. As the slider 130 moves forward, boss 148 connected to the end of caliper actuation cable 24 engages the slider rear wall 144 and is pulled forwardly along with the slider 130 (FIG. 11). As a result, caliper actuation cable 24 is drawn forward thereby actuating caliper 30 located as its opposite end. The tightening or forward movement of caliper actuation cable 24 causes caliper 30 and any attached resistance pads 31 to clamp around wheel 26, thereby performing a braking function on wheel 26. Upon release of the hand brake 56, a spring (not shown) moves the brake handle back to its resting position thereby loosening the brake cable 26 and releasing the slider 130, which then moves reawardly releasing the tension in caliper actuation cable 24, and releasing the caliper 30 and any attached pads from wheel 36.

During the braking process, as the brake cable 26 is drawn forward, the resistance adjustment cable 28 remains unaffected. The end of resistance adjustment cable 28 opposite the crimped end in the cradle 98 is essentially free. Thus, as slider 130 moves with brake cable 26, slider 130 moves forward and resistance adjustment cable 28 passes through hole 93 without encumbering the movement of slider 130.

While exerciser 20 has been shown and described with respect to specific embodiments, it is contemplated that various alternatives and modifications are also within the scope of the present invention. For example, and without limitation, the orientation of the exerciser 20 may vary considerably from that shown and described. For example, exerciser 20 could be a “front wheel” spin bike and include a more traditional X-frame, or may have any other construction. Likewise, although the resistance/braking mechanism is described as a caliper, other braking and resistance applying mechanisms can be utilized within the scope of the present invention. As noted throughout the application, applicant has provided for a cycling exerciser with a novel single cable actuator responsive to provide movement of separately attached resistance adjustment and brake cables. Therefore, numerous alternatives wherein the cycling exerciser includes a single cable actuator are included in the scope of the present invention.

It should also be understood that, while the invention has been shown and described in connection with dual cable actuation to control both resistance and braking using a single actuator cable, the intermediate member may also be actuated using dual levers (or a single lever) that are actuated using the brake actuator and resistance adjustment mechanism.

It is also contemplated that the present invention may be incorporated in any type of exercise device that has a rotary member which provides resistance and is capable of being braked, and is not limited to use in a cycling-type exercise device.

The above discussion, examples, and embodiments illustrate our current understanding of the invention. However, since many variations of the invention can be made without departing from the spirit and scope of the invention, the invention resides wholly in the claims hereafter appended.

We claim:

1. A single cable actuator assembly for an exercise device having a rotary member, the exercise device having rotation-impeding arrangement that acts on the rotary member to impede rotation of the rotary member, a cable operated resistance adjustment mechanism and a cable operated braking arrangement, comprising:
an actuation cable operably connected to the rotation-impeding arrangement;
an actuator movably mounted to the exercise device, wherein the actuation cable is interconnected with the actuator, and wherein a brake cable associated with the braking arrangement and a resistance adjustment cable associated with the resistance adjustment arrangement are interconnected with the actuator; and
wherein actuation of either the brake cable or the resistance adjustment cable moves the actuator to cause movement of the actuator and thereby operation of the resistance-impeding arrangement through the actuation cable.

2. The single cable actuator assembly of claim 1, wherein the actuator comprises:
a brake cable receiving cradle configured to retain the brake cable; and
a resistance adjustment cable receiving cradle configured to retain the resistance adjustment cable.

3. The single cable actuator assembly of claim 2, wherein the brake cable receiving cradle and the resistance adjustment cable receiving cradle define cavities configured to receive the respective brake cable and resistance adjustment cable, and further comprising a fastener for crimping the end of the cables.

4. The single cable actuator assembly of claim 1, further comprising an actuator receiving bracket mounted to a frame of the exerciser.

5. The single cable actuator assembly of claim 4, wherein a shroud configured to receive a water bottle covers the actuator receiving bracket.

6. The single cable actuator assembly of claim 1, wherein the actuator is a pivotally mounted swing plate.

7. The single cable actuator of claim 6, wherein the swing plate comprises a brake cable receiving cradle configured to retain the brake cable;
a resistance adjustment cable receiving cradle configured to retain the resistance adjustment cable and;
a caliper actuation cable configured to retain the caliper actuation cable.

8. The single cable actuator of claim 6, wherein the brake cable and the resistance adjustment cable are interconnected with the swing plate at a location inwardly of the actuation cable relative to a pivot axis of the swing plate.

9. The single cable actuator of claim 1, wherein the actuator is a rotatable spool.

10. The single cable actuator of claim 1, wherein the actuator is a slider, wherein the slider retains distal ends defined by the brake cable and the resistance adjustment cable and defining a rear wall connected to a forward end of the actuation cable.

11. The single cable actuator assembly of claim 10, wherein the rear wall of the slider defines a hole, and wherein the actuation cable extends through the hole and includes a boss connected to the actuation cable on the inside of the rear wall.

12. A method of mounting a single cable actuator assembly to a cycling exerciser, the cycling exerciser having a cable operated resistance adjustment mechanism, a cable operated braking system, and a caliper actuation cable operably connected to a caliper the method comprising:
mounting an actuator receiving bracket to a frame of the exerciser;
movably connecting an actuator to the actuator receiving bracket;
connecting the distal end of a brake cable to the actuator;
connecting the distal end of the resistance adjustment cable to the actuator; and
connecting the caliper actuation cable to the actuator such that movement of the actuator by the attached brake cable or the attached resistance adjustment cable actuates the caliper actuation cable.

13. The method of claim 12, wherein the steps of connecting the distal end of the resistance adjustment cable to the actuator and connecting the distal end of the brake cable to the actuator comprise placing the resistance adjustment cable into a cavity in a resistance adjustment cable receiving cradle and placing the brake cable into a cavity in a brake cable receiving cradle.

14. The method of claim 13, further comprising the step of crimping the ends of the resistance adjustment and brake cables with a fastener.

15. The method of claim 12, wherein the actuator is a pivotally mounted swing plate.

16. The method of claim 12, wherein the actuator is a spool configured to be rotatable around the actuator receiving bracket.

17. The method of claim 11, wherein the actuator is a slider, wherein the slider is slidably received within the actuator receiving bracket and retains the distal ends of the brake cable and the resistance adjustment cable.

18. A actuator arrangement for an exerciser having a rotatable member, comprising:
an actuator movably mounted to the exerciser;
a first user-operated input actuating member interconnected with the actuator;
a second user-operated input actuating member interconnected with the actuator; and
an output actuating member interconnected with the actuator, wherein movement of the actuator in response to either the first input actuating member or the second input actuating member functions to cause movement of the actuator to move the output actuating member; and
wherein the output actuating member functions to inhibit rotation of the rotatable member in response to movement of either the first input actuating member or the second input actuating member through the actuator.

19. The actuator arrangement of claim 18, wherein the actuator is pivotally mounted to the exerciser.

20. The actuator arrangement of claim 18, wherein the actuator is slidably mounted to the exerciser.

21. A cable-type actuating assembly, comprising:
an input member interconnected with an input actuator, wherein operation of the input actuator causes axial movement of the input member;
an output member; and
a pivoting intermediate operator between the input member and the output member, wherein the intermediate operator is pivotable about a pivot axis and includes a first engagement area with which the input member is engaged at a first location relative to the pivot axis, and a second engagement area with which the output member is engaged at a second location outwardly of the first location relative to the pivot axis, wherein axial movement of the input member by operation of the input actuator causes axial movement of the output member through the intermediate operator, and wherein engagement of the output member with the intermediate operator at the second location results in greater axial movement of the output member than the input member.

22. The actuating assembly of claim 21, wherein the input member comprises a flexible input member and wherein the output member comprises a flexible output member.

23. The actuating assembly of claim 22, wherein the intermediate operator includes an arcuate engagement area adjacent the second location, wherein the flexible input member is engaged with the arcuate engagement area to facilitate pivoting movement of the intermediate operator.

24. A method of actuating a device using an output member interconnected with the device, wherein axial movement of the output member actuates the device, comprising the acts of:
axially moving an input member connected to a pivotable intermediate operator, wherein the output member is connected to the intermediate operator, and wherein the intermediate operator is pivotable about a pivot axis; and
amplifying movement of the input member through the intermediate operator so that the output member moves a distance greater than the input member to actuate the device.

25. The method of claim 24, wherein the input member comprises a flexible input cable and the output member comprises a flexible output cable.

26. The method of claim 25, wherein the device comprises one of a resistance control or a brake control for an exercise device.

27. The method of claim 26, including a pair of input members, wherein a first one of the input members comprises a resistance control for an exercise device and a second one of the input members comprises a brake control for an exercise device.

28. The method of claim 25, wherein the flexible input cable is connected to the intermediate operator inwardly of the flexible output cable relative to the pivot axis of the intermediate operator.

29. The method of claim 28, further comprising the step of engaging the flexible input member with an arcuate engagement surface on the intermediate operator adjacent the connection of the flexible input member with the intermediate operator.
